(19) United States
(12) Patent Application Publication
(10) Pub. No.: US 2006/0214801 A1
(43) Pub. Date: Sep. 28, 2006

(54) Radio frequency tag and method for regulating the same

(76) Inventors: Nobuo Murofushi, Shizuoka (JP); Kouichi Sano, Shizuoka (JP); Yasuhito Kiji, Shizuoka (JP)

Correspondence Address: DLA PIPER RUDNICK GRAY CARY US LLP, P. O. BOX 9271, RESTON, VA, 20195, US

(21) Appl. No.: 11/368,433

(22) Filed: Mar. 7, 2006

(30) Foreign Application Priority Data
Mar. 25, 2005 (JP) P2005-088434

(51) Int. Cl. G08B 13/14

(52) U.S. Cl. 340/572.7

(57) ABSTRACT

An RF tag includes an IC chip and a dipole antenna both arranged on a dielectric base. The dipole antenna is composed of a pair of antenna patterns each of which is connected to respective feed points of the IC chip and extends in an opposite direction. When manufacturing the RF tag, length of the pair of antenna patterns is set so that the impedance matching between the IC chip and the dipole antenna is optimum in the air. When using the RF tag attached on an article, the extending ends of the antenna patterns are eliminated so that the length of the dipole antenna matches the wave-length of radio waves traveling through the article that the RF tag is attached.

### BACKGROUND OF THE INVENTION

1. Field of the Invention

This invention relates, in general, to a radio frequency transponder, such as an RFID (radio frequency identification) tag. In particular, the invention relates to an RFID tag including an IC chip and a dipole antenna arranged on a dielectric base and a method for regulating the length of the dipole antenna of the RFID tag when using the tag attached to a specific article.

2. Description of the Related Art

It becomes necessary to employ an apparatus exclusively designed to manufacture an RFID tag (hereinafter referred to as RF tag) which includes an IC chip having a radio communication section and a memory section and an antenna, as the IC chip is minutualized.

A method for manufacturing such RF tag may be that an antenna pattern is printed on a base and thereafter an IC chip is connected with the antenna pattern. Another method may be that an antenna pattern is printed after an IC chip is mounted on a base.

In such RF tag, it is generally required to conduct an impedance matching between the antenna and the IC chip to reduce an amount of an inputted signal that may be reflected and returned to the antenna when the signal is inputted to the IC chip from the antenna. An amount of such inputted signal reflected and returned may be increased due to failure to the impedance matching.

In addition, a resonance frequency is determined depending on the length of the antenna and therefore, it can effectively transmit the signal received by the antenna to the IC chip with the resonance of the antenna. Due to this operation, the length of the antenna is designed so as to be resonated with the frequency used in the communication.

In such antenna, the resonance frequency may be varied depending on the circumferential condition and the impedance thereof is also varied greatly. Thus, in the RF tag, it is desired to regulate the length of the antenna based on the condition that the RF tag is used. However, it is rather difficult to alter or change various constants and/or conditions of the RF tag manufacturing apparatus exclusively designed when the RF tag is manufactured varying the length of the antenna every several hundred units or several thousand units.

### SUMMARY OF THE INVENTION

Accordingly, it is an object of the present invention to easily regulate the length of a dipole antenna of RF tag when the RF tag is attached to a specific article.

To accomplish the above-object, a method for regulating an RF tag which includes an IC chip having a radio-communication section and a memory and a dipole antenna both arranged on a dielectric base, the dipole antenna having a pair of antenna patterns each extending from respective feed points of the IC chip, including the steps of: preparing the RF tag which is to be attached to an article; and eliminating the extending end of each antenna pattern so that the length of the dipole antenna matches a wave-length of radio waves traveling through the article to the RF tag.

The length of the dipole antenna of the prepared RF tag may be set so that an impedance matching between the IC chip and the dipole antenna is optimum in the air when manufacturing.

### BREIF DESCRIPTION OF THE DRAWINGS

These and other objects and advantages of this invention will become apparent and more readily appreciated from the following detailed description of the presently preferred exemplary embodiments of the invention taken in conjunction with the accompanying drawings wherein:

FIG. 1 is a block diagram illustrating a construction of an RF tag data read-out system using an RF tag and an interrogator;

FIGS. 2a and 2b are a view illustrating a construction of the RF tag of one embodiment of the present invention;

FIGS. 3a and 3b are a view illustrating a modification of the RF tag shown in FIG. 2;

FIG. 4 is a perspective view illustrating an overall construction of an example system using an RF tag;

FIGS. 5a and 5b are a view illustrating a construction of a second embodiment of the RF tag used in the system shown in FIG. 4;

FIG. 6 is a view illustrating a third embodiment of the RF tag;

FIG. 7 is a view illustrating a fourth embodiment of the RF tag; and

FIG. 8 is a view illustrating a fifth embodiment of the RF tag.

### DETAILED DESCRIPTION OF THE INVENTION

Preferred embodiments of the present invention will now be described in more detail with reference to the accompanying drawings. However, the same numerals are applied to the similar elements in the drawings, and therefore, the detailed descriptions thereof are not repeated.

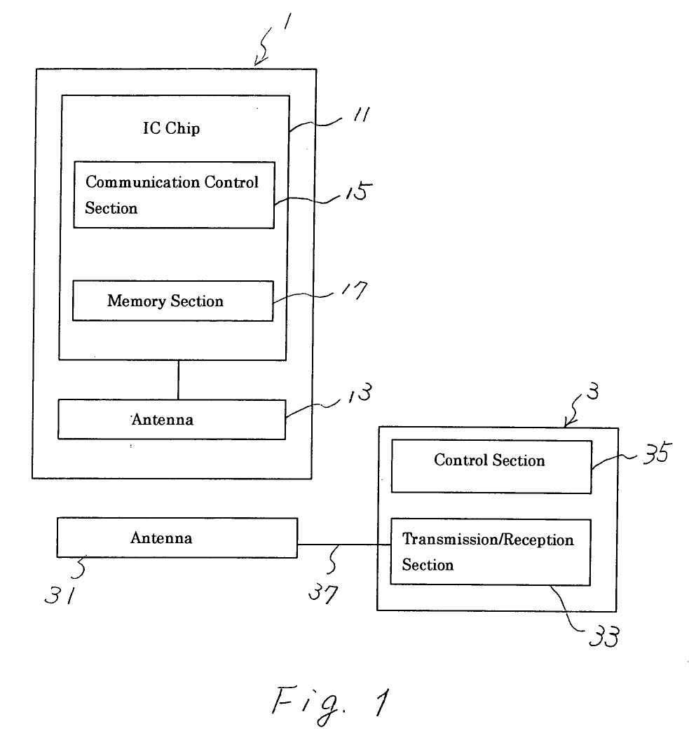

A first embodiment of the present invention will be described with reference to FIG. 1. FIG. 1 shows a block diagram illustrating the construction of an RF tag data read-out system using an RF tag 1 and an interrogator 3.

The RF tag 1 is constituted with an IC chip 11 and a dipole antenna 13 electrically connected to the IC chip 11 to receive or radiate radio waves from the antenna 13. The IC chip 11 includes a communication control section 15 that controls the communication operation and a memory section 17 that stores several data.

The interrogator 3 includes an antenna 31, a transmission/reception section 33 which carries out the transmission/reception operation and a control section 35 which controls the operation of the transmission/reception section 33. The transmission/reception section 33 is mechanically and electrically connected to the antenna 31 through a coaxial cable 37. The antenna 31 performs the transmission/reception of radio waves from or to the antenna 13 of the RF tag 1 through the coaxial cable 37.

An operation of transmitting data from the interrogator 3 to the RF tag 1 will be described with reference to FIG. 1.

A transmission data from the control section 35 is transmitted to the transmission/reception section 33. In the transmission/reception section 33, the transmission data is modulated to be converted to a high frequency signal and the high frequency signal is then output to the antenna 31 through the coaxial cable 37. The antenna 31 radiates the high frequency signal to the space as a radio signal.

The radio signal radiated from the antenna 31 is received by the antenna 13 of the RF tag 1 and is transmitted to the IC chip 11 as a high frequency signal. In the IC chip 11, the high frequency signal is demodulated to a received data by the radio communication section 15 and the received data is stored in the memory section 17. According to the contents of the received data, appropriate operations or processes are also performed.

An operation of outputting a reply data (acknowledgement) from the RF tag 1 to the interrogator 3 will be described.

In the radio communication section 15, the reply signal is modulated and converted to a high frequency signal (backscatter signal) and the high frequency signal is then transmitted to the antenna 13. The antenna 13 radiates the high frequency signal to the space as a radio signal.

The radio signal radiated from the RF tag 1 is received by the antenna 31 of the interrogator 3 and transmitted to the transmission/reception section 33 through the coaxial cable 37 as a high frequency signal. In the transmission/reception section 33, the high frequency signal is demodulated and the demodulated reply data is sent to the control section 35.

As is described above, the interrogator 3 performs a radio-communication with the RF tag 1 to receive data stored in the memory section 17 of the RF tag 1 or to send the RF tag 1 data to be stored in the memory section 17 of the RF tag 1.

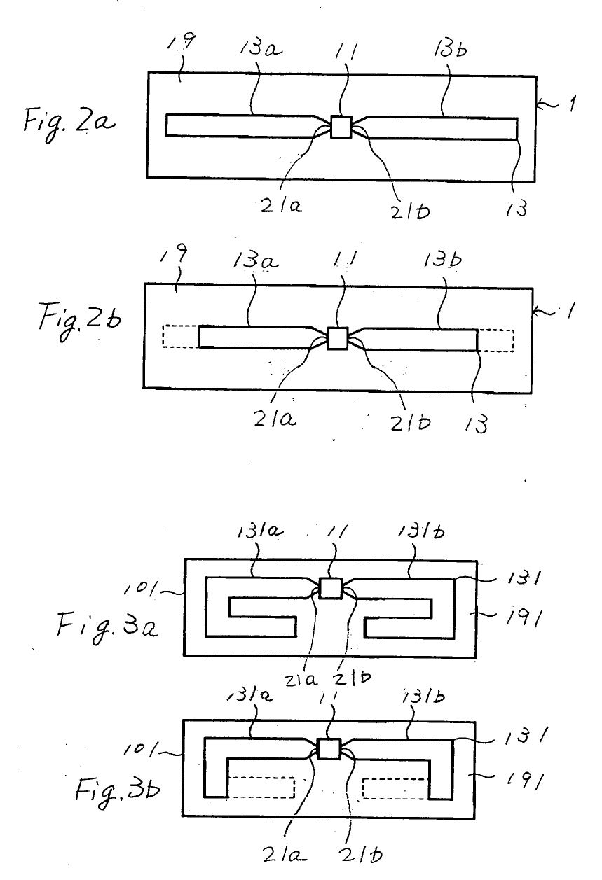

As can be seen in FIG. 2a, the IC chip 11 and the dipole antenna 13 of the RF tag 1 used in this system are arranged on a dielectric base 19. The dipole antenna 13 is formed with a pair of antenna patterns 13a and 13b of the same shape. The pair of antenna patterns 13a and 13b is formed with a material having an electro-conductivity and arranged on the base 19 such that each antenna pattern 13a, 13b is respectively located at opposite sides of the IC chip 11 in line and electrically connected to respective terminals of the IC chip 11. Each connecting point between the IC chip 11 and the antenna 13 serves as a feed point 21a, 21b. The above-described dielectric base 19 may be a sheet shaped substrate of polypropylene or a substrate of a solid material having some thickness like a board.

A length of each antenna pattern 13a, 13b of the dipole antenna 13 shown in FIG. 2a is set to an appropriate length that an impedance matching between the IC chip 11 and the antenna 13 is optimum in the air. That is, an appropriate matching property can be achieved in the state that any material other than the air is not present near or around the RF tag 1. A state that the impedance matching between the IC chip 11 and the antenna 13 is optimum is of that power from the antenna 13 to the IC chip 11 is transmitted effectively and thereby being capable to make the available communication distance between the RF tag 1 and the antenna 31 of the interrogator 3 longer.

Radio waves sent to the RF tag 1 may receive an influence from material of an article on which the RF tag 1 is mounted. A wave-length of the radio waves becomes shorter when the radio waves are transmitted through the material of a high dielectric constant. A wave-length (λ) in a dielectric material is expressed by the following formula:

$$λ = \frac{λ o}{\sqrt{( μ R * ɛ R )}}$$

wherein

λo is a wave-length in a free space,

μR is a relative permeability, and

εR is a relative dielectric constant.

A relative permeability of ordinary dielectric material is one (1). A wave-length (λ) in a dielectric material is determined by the relative dielectric constant (εR). A relative dielectric constant (εR) of the air is one (1) and a relative dielectric constant (εR) of solid material is larger than one (1) and thus, the higher the dielectric constant of a material the shorter the wave-length of radio waves traveling through the material.

When two different materials (articles) each having a same dielectric constant and a different thickness are respectively located at a same distance from the antenna, there is a tendency, on the one hand, that the thicker the thickness of the material (article) the lower the resonance frequency of the antenna. On the other hand, there is a tendency also that the nearer the material (article) to the antenna the lower the resonance frequency of the antenna even if the same material (article) is used. Thus, it is desirable to determine the length of each antenna pattern 13a, 13b of the dipole antenna 13 depending on a dielectric constant and a thickness of a material (article) located close to the RF tag 1 and a presumed distance between the RF tag 1 and the antenna 13 when the RF tag 1 is actually used. It may be operated even if each length of antenna patterns 13a and 13b is different in a little each other but, it is desirable to make each length of antenna patterns 13a and 13b in the same shape to achieve a high efficiency.

Based on the above discussion, it is required to regulate the length of the antenna patterns 13a and 13b to be matched with the wave-length of radio waves traveling through a material (article) when the RF tag 1 is mounted on the article. As shown in FIG. 2b, each end portion (dotted portion) of the antenna pattern 13a, 13b opposite to each feed point 21a, 21b is eliminated. Eliminating methods may be a process, e.g., scratching, stripping or etching.

In the above-described method, the end portion of only each antenna pattern 13a, 13b is eliminated. However, if a sheet type dielectric base is used, the end portion of each antenna pattern 13a, 13b may be cut off together with the corresponding portion of the sheet type base. It may also be performed that the end portion of each antenna pattern 13a, 13b is eliminated by punching together with the portion of the sheet type base.

As described above, the length of the antenna patterns 13a and 13b of the dipole antenna 13 of the RF tag 1 is regulated to match the length of each antenna pattern 13a, 13b with the wave-length of radio waves traveling through the article on which the RF tag 1 is mounted. Thus, the RF tag which is suitable for conditions that the RF tag is used can be made only by eliminating end portion of the antenna patterns 13a and 13b.

In this regulation process, it may originally prepare one kind of RF tag 1 having a dipole antenna 13 the length of which is matched with the relative dielectric constant in the air (smallest relative dielectric constant). Therefore, a large volume of RF tag of this kind can be manufactured beforehand. When using such RF tags, each antenna pattern is regulated such that the end portion of each antenna pattern is eliminated, as described above, so as to match the length of the antenna with the wave-length of radio waves traveling through the article on which the RF tag is attached. A manufacturing cost of the RF tags can be decreased.

In the above-described embodiment, the RF tag 1 having the dipole antenna 13 whose antenna pattern 13a, 13b is formed linearly in the same shape at both sides of the IC chip 11 and is respectively connected to the IC chip 11 is used. However, the shape of the dipole antenna (antenna pattern) is not limited to this, and thus, as shown in FIG. 3a, it may use an RF tag 101 having a dipole antenna 131 and an IC chip 11 arranged on a base 191 of dielectric material. The dipole antenna 131 includes antenna pattern 131a, 131b which is formed in the same shape at both sides of the IC chip 11 such that a middle portion of each antenna pattern 131a, 131b is bent twice like a U-shape (sub pattern elements). One end portion of each antenna pattern 131a, 131b adjacent to the IC chip 11 is electrically connected to the IC chip 11, respectively. The entire length of the RF tag 101 including such dipole antenna 131 can be minimized.

When using such RF tag 101, a bent portion of each antenna pattern 131a, 131b is eliminated, indicated in a phantom line, to regulate the length thereof, as shown in FIG. 3b.

### Second Embodiment

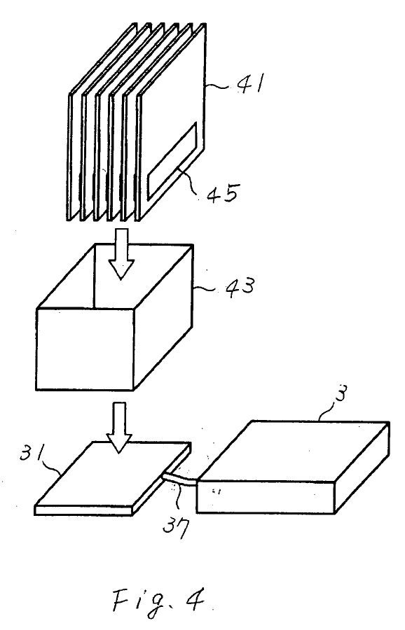

As shown in FIG. 4, a plurality of document files (article) 41 is housed in a container 43. An RF tag 45 is attached to the lower side of each file 41 and each RF tag 45 has a memory that stores a unique ID data different from other RF tags. The plurality of document files 41 each having RF tag 45 are contained in the container 43 such that the RF tags 45 of the files 41 are located nearest to the bottom of the container 43.

When making the container 43 in which the plurality of files 41 have been housed approach the antenna 31 of the interrogator 3, a radio communication between the antenna 31 and the antenna of each RF tag 45 is executed and the interrogator 3 reads out the unique ID data from the memory of each RF tag 45 to manage the plurality of files 41 in the container 43. The antenna 31 of the interrogator 3 has a characteristic that the radio waves from the antenna 31 are intensively radiated toward the bottom of the container 43 in FIG. 4.

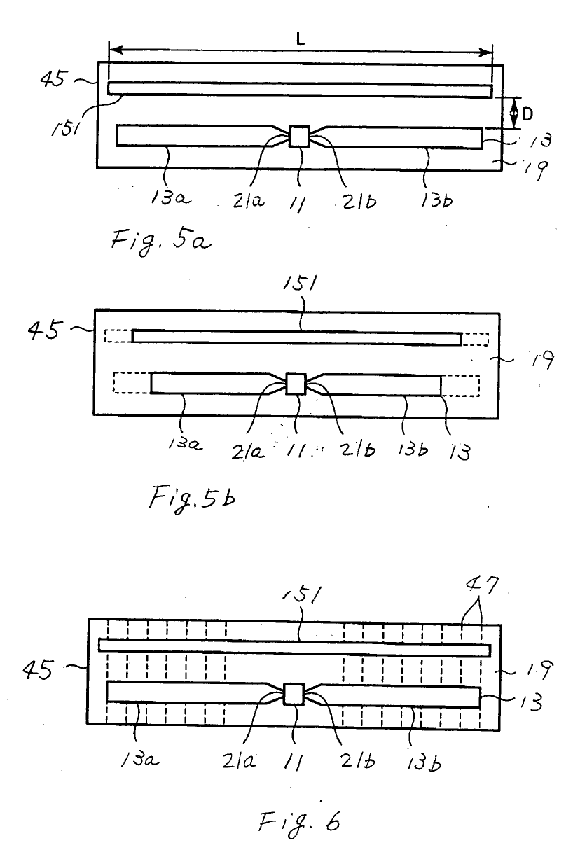

As shown in FIG. 5a, the RF tag 45 includes an IC chip 11 and the dipole antenna 13 arranged on a dielectric base 19. The dipole antenna 13 has a pair of antenna patterns 13a, 13b linearly arranged at opposite sides of the IC chip 11, respectively. A lengthwise reflecting element 151 is arranged on the base 19 in parallel to the dipole antenna 13 at a predetermined distance D. The RF tag 45 is attached to the file 41 so as to locate the reflecting element 151 far from the antenna 31 of the interrogator 3 relative to the dipole antenna 13.

In FIG. 5a, the length of antenna patterns 13a and 13b of the dipole antenna 13 is set to a specific length that the impedance matching between the IC chip 11 and the dipole antenna 13 is made to be appropriate. The distance D between the dipole antenna 13 and the reflecting element 151 and the length L of the reflecting element 151 are set to make the transmission/reception characteristic of the RF tag 45 optimum in the air.

FIG. 5b shows the RF tag 45 that is to be attached to the document file 41. Both end portions of antenna pattern 13a, 13b of the dipole antenna 13 are eliminated, as indicated by a dotted line and opposite ends of the reflecting element 151 are also eliminated, as shown in a dotted line. Thus, the length of each antenna pattern 13a, 13b is regulated so that it matches the wave-length of the radio waves traveling through the file 41 that the RF tag 45 is to be attached. The transmission/reception characteristic of the RF tag 45 is improved and it can receive the radio waves from the antenna 31 of the interrogator 3 intensively.

When the reflecting element 151 is used, radio waves received by the dipole antenna 13 of the RF tag 45 and radio waves reflected by the reflecting element 151 both are received by the RF tag 45 as the radio waves radiated from the antenna 31 of the interrogator 3 and thus, the radio waves from the antenna 31 can be intensively received by the antenna 13 of the RF tag 45. An effective reception of radio waves from the interrogator 3 can be achieved.

As shown in FIG. 4, RF tags 45 each attached to respective document files 41 are located in parallel through the file 41 of a dielectric material in the container 43. The RF tag 45 in the container 43 receives influences from both the file 41 and other RF tags adjacent to the RF tag 45. To decrease such influences, the RF tag 45 intensively receives the radio waves from the antenna 31 of the interrogator 3.

In this embodiment also, it may originally prepare one kind of RF tag 45 having a dipole antenna 13 the length of the antenna patterns 13a and 13b of which is set in accordance with the relative dielectric constant in the air (smallest relative dielectric constant). Therefore, a large volume of RF tag of this kind can be manufactured beforehand. When using such RF tags, each antenna pattern is regulated such that the end portion of each antenna pattern is eliminated, as described above, so as to match the length of the antenna pattern with the wave-length of radio waves traveling through the article on which the RF tag is attached. A manufacturing cost of the RF tags can be decreased.

### Third Embodiment

Another modification of the RF tag will also be described hereinafter.

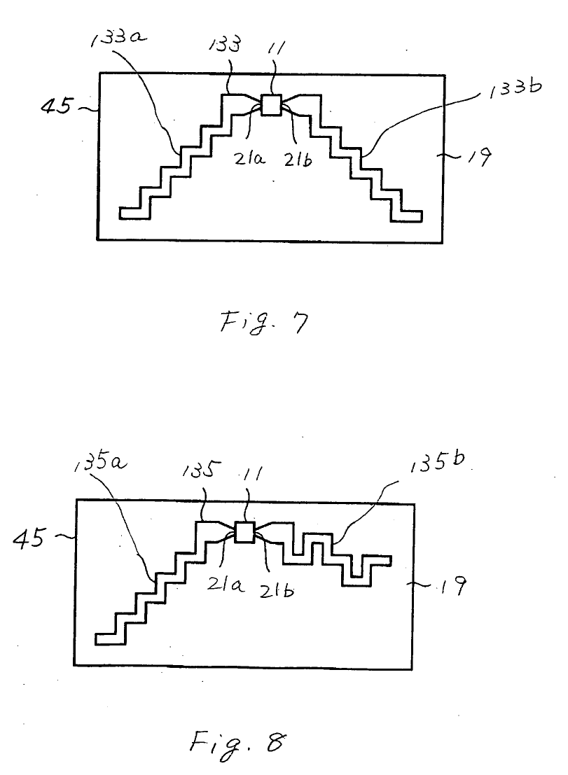

As shown in FIG. 6, a plurality of marks 47 (dotted line) acting as an indicator are printed on the dielectric base 19 such that the marks 47 are located orthogonal to and along the respective patterns 13a and 13b and each location of corresponding marks 47 along the respective patterns 13a and 13b is an equally distance from the respective feed points 21a, 21b of the IC chip 11.

When applying the RF tag 45 shown in FIG. 6 to an article, such as a document file, length of the antenna patterns 13a and 13b is regulated to be matched with the wave-length of radio waves traveling through the article such that it is eliminated at a location of marks 47. The elimination operation is easily carried out using the plurality of marks 47 and each length of the antenna patterns 13a and 13b can be equally eliminated at the corresponding marks 47.

In the above-described embodiment, a plurality of marks 47 is printed as an indicator on the dielectric base 19 and corresponding marks indicate same distances of respective antenna patterns 13a and 13b from each feed point 21a, 21b of the IC chip 11. However, the equally distances from respective feed points 21a, 21b may be indicated with variation in color or variation in pattern. It may also be indicated by corresponding notches that are formed on the dielectric base 19.

### Fourth Embodiment

A modification of the antenna pattern of the RF tag will be described hereafter.

As shown in FIG. 7, stepped-shape antenna patterns 133a and 133b are symmetrically formed on the dielectric base 19 with respect to the IC chip 11 and each antenna pattern 133a, 133b is connected to the respective feed points 21a, 21b of the IC chip 11. Each antenna pattern 133a, 133b includes a plurality of stepped shape elements (sub pattern elements). Corresponding stepped shape elements of antenna patterns 133a and 133b indicate an equally distance from each feed point 21a, 21b.

In the above-described embodiment, the length of the antenna patterns 133a, 133b is regulated such that end portions of the antenna patterns 133a and 133b from respective specified steps that are located at an equally distance from each feed point 21a, 21b are eliminated. Thus, the antenna patterns 133a and 133b can be easily adjusted to the same length from respective feed points 21a, 21b of the IC chip 11.

### Fifth Embodiment

Another modification of the antenna pattern of the RF tag will also be described hereinafter.

As shown in FIG. 8, a pair of antenna patterns 135a and 135b are formed on the dielectric base 19 and each antenna pattern 135a, 135b is connected to the respective feed points 21a, 21b of the IC chip 11. One of the antenna patterns 135a is different from the other antenna pattern 135b. One of the antenna pattern 135a includes a plurality of stepped shape elements (sub pattern elements), as similar to the antenna patterns 133a and 133b of the fourth embodiment. The other antenna pattern 135b includes a plurality of cranked shape elements (sub pattern elements). Corresponding elements of each antenna pattern 135a, 135b are bent at right angles at a same distance from the corresponding feed points 21a and 21b.

In the above-described embodiment, the length of the antenna patterns 135a, 135b is regulated such that end portions of the antenna patterns 135a, 135b from respective specified bent portions that are located at an equally distance from each feed point 21a, 21b are eliminated, as similar to the fourth embodiment. Thus, the antenna patterns 135a and 135b can be easily adjusted to the same length from respective feed points 21a, 21b of the IC chip 11.

The present invention has been described with respect to specific embodiments. However, other embodiments based on the principles of the present invention should be obvious to those of ordinary skill in the art. Such embodiments are intended to be covered by the claims.

What is claimed is:

1. A method for regulating an RF tag which includes an IC chip having a radio-communication section and a memory and a dipole antenna arranged on a dielectric base, the dipole antenna having a pair of antenna patterns each extending from respective feed points of the IC chip, including the steps of:
preparing the RF tag which is to be attached to an article; and
eliminating the extending end of each antenna pattern so that the length of the dipole antenna matches a wave-length of radio waves traveling through the article to the RF tag.

2. A method according to claim 1, wherein the dielectric base is a sheet type base, and the portion of the extending end of each antenna pattern is cut together with the corresponding portion of the sheet type base.

3. A method according to claim 1, wherein the length of the dipole antenna of the prepared RF tag is set so that an impedance matching between the IC chip and the dipole antenna is optimum in the air.

4. A method according to claim 1, wherein the RF tag further includes a reflecting element extending along the dipole antenna on the dielectric base, and the extending ends of the reflecting element are eliminated in response to the length of the antenna patterns regulated.

5. An RF tag which is to be attached to an article, including:
an IC chip having a radio-communication section and a memory, the IC chip also having a pair of feed points each positioned opposite to one the other;
a dipole antenna having a pair of antenna patterns each extending from the respective feed points of the IC chip;
a dielectric base on which the IC chip and the dipole antenna are arranged; and
a plurality of pair of indicators arranged along the pair of antenna patterns on the dielectric base, the pair of indicators indicating a same distance from the respective feed points of the IC chip,
wherein the extending end of each antenna pattern is eliminated along one of the plurality of pair of indicators to match the length of the dipole antenna with a wave-length of radio waves traveling to the RF tag through the article that the RF tag is attached when the length of the dipole antenna is regulated.

6. An RF tag which is to be attached to an article, including:
an IC chip having a radio-communication section and a memory, the IC chip also having a pair of feed points each positioned opposite to one the other;
a dipole antenna having a pair of antenna patterns each extending from the respective feed points of the IC chip, the pair of antenna patterns respectively having a plurality of sub pattern elements and the corresponding sub pattern elements of the pair of antenna patterns being bent at a same distance from the respective feed points of the IC chip; and
a dielectric base on which the IC chip and the dipole antenna are arranged,
wherein the extending end of each antenna pattern is eliminated such that at least one of the sub pattern elements of each antenna pattern at the same distance from the respective feed points is eliminated to match the length of the dipole antenna with a wave-length of radio waves traveling to the RF tag through the article that the RF tag is attached when the length of the dipole antenna is regulated.
